(19) United States
(12) Patent Application Publication
(10) Pub. No.: US 2026/0084743 A1
(43) Pub. Date: Mar. 26, 2026

(54) STEERING ACTUATOR FOR A STEERING SYSTEM OF A MOTOR VEHICLE

(71) Applicants: thyssenkrupp Presta AG, Eschen (LI); thyssenkrupp AG, Essen (DE)

(72) Inventors: Philippe STECK, Gamprin-Bendern (LI); Wolfram RAITHER, Sevelen (CH); Lukas MAZZA, Sennwald (CH)

(73) Assignees: thyssenkrupp Presta AG, Eschen (LI); thyssenkrupp AG, Essen (DE)

(21) Appl. No.: 19/338,910

(22) Filed: Sep. 24, 2025

(30) Foreign Application Priority Data
Sep. 25, 2024 (DE) 10 2024 127 829.3

(51) Int. Cl. B62D 5/04; B62D 5/00; B62D 15/02

(52) U.S. Cl. CPC B62D 5/0448; B62D 5/001; B62D 15/0215

(57) ABSTRACT

A steering actuator for a steering system of a motor vehicle comprises an actuator rod which is linearly movable translationally axially in its longitudinal direction relative to a sliding bush and which has a measuring portion which is displaceably mounted in an opening in the sliding bush, further comprising a drive device, wherein the measuring portion and the sliding bush have a sensor apparatus which is designed to detect at least one actuator parameter. In order to allow a lower level of expenditure on design and manufacture and improved flexibility in terms of application, the invention proposes that a sliding sleeve, which extends in the longitudinal direction over the measuring portion, is fitted on the actuator rod.

### CROSS REFERENCE TO RELATED APPLICATION

This application is a U.S. Non-Provisional that claims priority to German Patent Application No. DE 10 2024 127 829.3, filed Sep. 25, 2024, the entire content of which is incorporated herein by reference.

### FIELD

The present disclosure relates to a steering actuator for a steering system of a motor vehicle.

### BACKGROUND

In a motor vehicle steering system, a steering actuator is used to produce the mechanical steering angle of one or more steerable wheels.

A steering actuator of this generic type has an actuator rod which is adjustable in its longitudinal direction, i.e. axially with respect to its longitudinal axis, usually transversely to the direction of travel relative to the vehicle body. The actuator rod can be connected in an articulated manner to the axle members of two steerable wheels of a vehicle axle, or in the case of a single wheel steering system accordingly connected to a single steerable wheel. The translational axial displacement of the actuator rod creates a mechanical steering angle of the steerable wheel or wheels.

In order to produce a steering angle, the actuator rod can be axially translationally moved by means of a drive device. This drive device can have a manual force introducing apparatus, as is known from a conventional toothed rack steering system for example. As an alternative or in addition, a motorized drive or auxiliary force drive can be provided. This drive comprises a drive device with an electric motor which can couple an axial steering or actuator force into the actuator rod via a toothed rack or spindle drive for example.

The actuator rod is mounted in the steering actuator axially displaceably in a sliding bush which is arranged in a housing fixed to the vehicle body, the actuator housing or the transmission housing.

In order to monitor functioning and to implement motorized actuation, it is known to provide a sensor apparatus, which has at least one electrical sensor which is designed to detect at least one current actuator parameter and to output a corresponding electrical measurement value. The actuator parameter detected may be, for example, the position of the actuator rod, as is described in DE 10 2021 205 316 A1 for example, wherein the sensor has a running wheel which interacts with the actuator rod. As an alternative, DE 199 15 105 A1 proposes mounting the actuator rod in a linearly displaceably sliding manner in a sliding bush. Axially successive markings made in a measuring portion of the actuator rod can be detected by means of a sensor element, which is designed as a detector, in the region of the sliding bush for detecting the position of the actuator rod.

The known sensor apparatuses allow measurement of different actuator parameters, for example detection of the position of the actuator rod. However, machining of the actuator rod, for example to make a tooth system or sensor markings, is always required in order to form or fit the sensor elements. This results in a relatively high level of expenditure on design and manufacture and a relatively high level of expenditure for adapting to different steering actuator designs.

Thus a need exists to allow a lower level of expenditure on design and manufacture and improved flexibility in terms of application.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic illustration of a steering system.

FIG. 2 shows a cross section B-B through the steering actuator according to FIG. 1.

FIG. 3 shows a longitudinal section along axis A through the steering actuator according to FIG. 1.

FIG. 4 shows a view of the actuator rod of the steering actuator according to FIGS. 2 and 3 schematically in isolation.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

Some embodiments include a steering actuator for a steering system of a motor vehicle, comprising an actuator rod which is linearly movable translationally axially in its longitudinal direction relative to a sliding bush and which has a measuring portion which is displaceably mounted in an opening in the sliding bush, further comprising a drive device, wherein the measuring portion and the sliding bush have a sensor apparatus which is designed to detect at least one actuator parameter.

In a steering actuator for a steering system of a motor vehicle, comprising an actuator rod which is linearly movable translationally axially in its longitudinal direction relative to a sliding bush and which has a measuring portion which is displaceably mounted in an opening in the sliding bush, further comprising a drive device, wherein the measuring portion and the sliding bush have a sensor apparatus which is designed to detect at least one actuator parameter, provision is made according to the invention for a sliding sleeve, which extends in the longitudinal direction over the measuring portion, to be fitted on the actuator rod.

According to the invention, a sliding sleeve is initially provided separately and then fitted coaxially on the outer periphery of the actuator rod. Axially, i.e. in the longitudinal direction defined by the longitudinal axis of the actuator rod, the sliding sleeve is preferably at least as long as the measuring portion and encompasses this measuring portion.

The outer cross section of the sliding sleeve, which has an outer contour of the actuator rod, the outer contour being provided by the cross-sectional profile and encircling the longitudinal axis, is adapted to the inner cross section or opening cross section of the opening in the sliding bush in order to implement linear sliding bearing of the actuator rod in the sliding bush.

The actuator rod according to the invention has a main body with a receiving portion which extends in the longitudinal direction and on which the sliding sleeve is fixed axially fixedly and rotationally conjointly with respect to rotation about the longitudinal axis. The sliding sleeve is arranged coaxially on the main body in the receiving portion. The sliding sleeve accordingly forms a kind of sheath or cover of the actuator rod in the region of the measuring portion, the actuator rod being held in a linearly movable manner in the sliding bush.

Since the sliding sleeve can be adapted to the receiving portion of the main body in a flexible manner and with a low level of expenditure solely by way of the configuration of the receiving opening, it is advantageously possible to reduce the expenditure on machining for the actuator rod itself.

For example, it is possible to manufacture the main body of the actuator rod from a sufficiently dimensionally stable raw material, such as for example drawn, cylindrical or polygonal steel rod material which can retain its original shape in the region of the receiving portion for the sliding sleeve according to the invention. The sliding sleeve can be fitted on the main body according to the invention and preferably without further machining of the sliding sleeve, so that costly machining of the raw material in order to adapt to the inner cross section of the sliding bush is not required in this region, as was previously the case.

A further advantage is that the outer cross section of the sliding sleeve can be configured largely independently of the outer cross section of the main body of the actuator rod. As a result, different embodiments of actuator rods and/or sliding bushes can be adapted to each other with a relatively low level of expenditure on design and manufacture, so that, for example, an actuator rod based on a standardized main body can be used in different steering mechanisms with different sliding bushes. In other words, the actuator rod can be adapted to the guide in the sliding sleeve by way of the configuration of the sliding sleeve with a low level of expenditure.

In a further advantageous embodiment, the measuring portion can be designed without a sensor apparatus. Here, the portion forms a region which is designed solely for sliding bearing of the actuator rod with security against rotation.

Provision is preferably made for the sliding sleeve to have a hollow body. The hollow body can preferably be designed in the form of a tubular profile or tube. The hollow body can have an axial receiving opening which corresponds in terms of shape and dimensions to a receiving portion of the main body and which can preferably be designed as an axially continuous passage opening. This receiving opening is configured in terms of its shape and dimensions and adapted to the outer profile of the main body of the actuator rod in the receiving portion in such a way as to allow axially fixed and rotationally conjoint connection.

The outer cross section of the hollow body is adapted to the opening cross section (inner cross section) of the sliding sleeve in terms of shape and dimensions in order to form the sliding bearing.

The hollow body can be designed to be continuous over its entire length, or to be circumferentially closed at least in portions preferably over its periphery.

The length of the hollow body, measured axially in the longitudinal direction, is equal to, or preferably greater than, the length of the measuring portion, which is mounted in a linearly displaceably sliding manner in the sliding bush.

For fitting purposes, the hollow body can be coaxially push-mounted onto the main body of the actuator rod in the axial direction until it sits in the region of the measuring portion, and can be fixed there. In order to receive the sliding sleeve, the receiving portion of the main body is designed to be at least as long as the hollow body.

It is advantageous for the hollow body to have a receiving opening with a receiving cross section which has a cross-sectional shape that differs from the outer cross section. The receiving cross section corresponds to the axially open passage cross section of the axially continuous receiving opening in the hollow body, which is adapted to the cross-sectional shape of the main body in the region of the receiving portion for fixing purposes. This cross-sectional shape can preferably be provided, as described above, by the unmachined original cross section of the raw material, and may be circular in the case of a cylindrical raw material for example.

The outer cross section of the sliding sleeve, the outer cross section being adapted to the inner cross section of the sliding bush, can preferably be of non-round configuration, preferably with a polygonal, for example triangular, basic cross section, in order to form rotationally secure sliding bearing. The shape of the outer cross section can be designed to differ from the shape of the inner cross section of the sliding sleeve. However, it is also possible for the basic shape to be the same, and for only the dimensions to differ.

Corresponding configuration of the sliding sleeve according to the invention allows manufacturing-related and functional or measurement-related optimization to be implemented independently of each other. For example, for efficient manufacture of the actuator rod, readily available round material can be used, on which, in an unmachined cylindrical portion, the sliding sleeve which has a polygonal outer cross section on the outside and is slidingly guided in an interlockingly rotationally secure manner in the sliding bush is fixed.

Provision is preferably made for the sliding sleeve to be connected to the actuator rod rotationally conjointly and fixedly in the longitudinal direction. As a result, the sliding sleeve is coaxially fixedly fixed to the actuator rod axially in the direction of the longitudinal axis and with respect to rotation about the longitudinal axis.

The fixing operation can be performed by way of the sliding sleeve being connected to the actuator rod in a substance-to-substance bonded and/or interlocking and/or force-fitting manner. Fixing of the sliding sleeve can be optimized in terms of manufacture and adapted to the loads during operation. A substance-to-substance bonded connection can be made, for example, by adhesive bonding or welding and ensures secure holding when the sliding sleeve is fixed on a cylindrical portion of the main body of the actuator rod. It is also possible for the sliding sleeve and the actuator rod to have corresponding interlocking elements which create an interlocking connection which acts axially and/or with respect to rotation about the longitudinal axis. This can be implemented, for example, by a non-round cross section of the main body and the receiving opening in the sliding sleeve. In addition or as an alternative, a force-fitting connection can be implemented, for example by corresponding frictional engagement elements.

It is possible for the sliding sleeve to be held in the sliding bush in a rotationally secure manner. This ensures that the actuator rod with the sliding sleeve fitted thereon rotationally conjointly with respect to rotation about the longitudinal axis can be moved solely in the longitudinal direction linearly relative to the sliding bush.

The sliding sleeve can preferably be of torsionally stiff design. Since the sliding sleeve itself and also the connection to the actuator rod with respect to rotation about the longitudinal axis is of torsionally stiff design, it is possible to ensure that no rotation of the actuator rod or of the main body of the actuator rod relative to the sliding bush secured fixed in position on the steering actuator can occur during operation. The advantage that can be implemented as a result is unambiguous and precise orientation of the actuator rod relative to the sliding bush and a correspondingly high degree of measurement accuracy with respect to position detection and possibly measurement of torsional and/or bending moments acting on the actuator rod.

It may be advantageous for the sliding sleeve to be of flexurally slack design. Flexurally slack design means that the sliding sleeve generates substantially no restoring force, or a restoring force that is negligible in terms of measurement, counter to the bending moment when the actuator rod is bent transversely to the longitudinal direction. If the sensor apparatus is intended to measure a bending load acting on the actuator rod, the advantage is that the measurement result is not adversely affected by the sliding sleeve. In practice, a flexurally soft or flexurally slack design can be implemented by using a readily deformable material with a low level of dimensional stiffness, for example a plastics material or the like.

As an alternative to the abovementioned design, it is possible for the sliding sleeve to be of flexurally rigid design. In this case, provision is made for the sliding sleeve itself to have a defined flexural stiffness which exerts a defined return moment in the event of a bending load acting on the actuator rod and thus increases the flexural stiffness of the arrangement formed by the actuator rod and the sliding sleeve according to the invention. The sliding sleeve can therefore be used as an additional mechanical supporting element for increasing the rigidity of the actuator rod.

It is preferably possible for the sliding bush and the sliding sleeve to have corresponding sensor elements. In this case, a measuring device, which can have measuring devices at least partially integrated with the sliding bush, is provided in the region of the sliding bush. This measuring device comprises at least one active detector or sensor element which, in accordance with a specified measurement method, can detect the relative or absolute position of corresponding sensor elements which are connected to the actuator rod, for example markings or scales for position detection in the longitudinal direction. For example, capacitive, inductive, resistive, magnetic, optical or other measuring methods that are known per se and are suitable for detecting the actuator parameters can be used for this purpose. According to the invention, provision is preferably made for the sliding sleeve to have the sensor elements which are connected to the actuator rod. Therefore, these sensor elements do not have to be inserted into the actuator rod itself, for example into the main body, but rather can be integrated into the sliding sleeve according to the invention.

This has several advantages. First of all, no additional machining of the actuator rod is required for fitting the sensor elements. These sensor elements can simply be mounted when the sliding sleeve is fitted to the actuator rod. Furthermore, it is possible to provide different sensor elements, which are adapted to the respective requirements, on a standardized main body of the actuator rod with a low level of expenditure simply by corresponding configuration of the sliding sleeve. It is therefore possible to change or adapt the measurement principle, or the sensor geometry, without changing the shape of the actuator rod. As a result, flexibility can be increased and the expenditure on manufacture can be reduced.

It is expedient for the sensor elements to be designed to detect a linear movement of the actuator rod relative to the sliding bush. For this purpose, a transmitter/receiver arrangement that is known per se can be provided in order to detect absolute or relative position measurement values in the direction of the longitudinal axis, for example capacitive, inductive incremental encoders, optical measuring elements or the like. As a result, the instantaneous position of the actuator rod in the steering actuator, which instantaneous position is correlated to the mechanical steering angle of the wheel or wheels steered by the steering actuator, can be reliably and accurately detected.

It is possible for the sensor elements to be designed to detect a bending and/or torsional moment applied between the actuator rod and the sliding bush. In addition or as an alternative to position detection, sensor elements which respond to deformation of the actuator rod can be provided. Elastic torsion and/or bending of the actuator rod can be created by the forces acting during operation. Monitoring of these actuator parameters allows monitoring of the load during operation, and thus reliable identification of potentially harmful overloads or malfunctions.

It is advantageous for the sliding sleeve to comprise a plastic. The sliding sleeve can have, for example, a tube-like or tubular profile-like plastic hollow body. This hollow body can expediently be provided, for example, from a thermoplastic polymer as a plastic injection-moulded part. It is conceivable and possible here to design at least one sensor element to be integrated with the plastic part, preferably by a non-releasable connection. It is possible, for example, to embed a capacitive, inductive or other sensor element in the plastic, for example by encapsulation with plastic in an injection-moulding process.

It is likewise conceivable and possible to produce the sliding sleeve from a composite plastic material in order to create a higher degree of stiffness.

Forming the sliding sleeve from plastic also allows optimization of the sliding properties of linear sliding bearing of the actuator rod in the stationary sliding bush. For example, this sliding bush can likewise comprise, at least in the region of its passage opening, a plastic which is selected with a view to particularly low-friction frictional pairing with the material of the sliding sleeve.

It is possible for the actuator rod to have a main body which is formed from steel. The raw material used may be, for example, drawn round steel material or the like.

The main body can preferably be designed for interaction with the drive device. For example, it is possible for the drive device to have a spindle drive which can be driven by motor. In this case, the actuator rod has a spindle thread which extends over an axial threaded portion and engages into a spindle nut. This spindle nut is supported in a manner axially fixed in position and can be driven in rotation relative to the threaded shaft of the actuator rod by a motor. In accordance with the functional principle of a spindle drive known per se, specifically a plunger spindle drive, motor-driven rotation of the spindle nut is converted into linear axial movement of the actuator rod. The spindle drive may preferably be designed as a ball screw drive (KGT), the spindle nut being designed as a ball nut (recirculating ball nut) and the spindle thread being designed as a corresponding ball screw.

When using a spindle drive, the actuator rod is preferably fixed in the sliding bush with respect to rotation about the thread axis (spindle axis), preferably due to a non-round outer cross section, which is held in the sliding sleeve in an interlocking manner, of the sliding sleeve according to the invention. Suitable sensor elements can be used to monitor the axial compression and tensile forces introduced between the spindle thread and the sliding bush, and also torsional forces transmitted by the spindle thread. As a result, the functioning of the spindle drive and the sliding bush can be advantageously monitored during ongoing operation.

It is likewise conceivable and possible for the drive unit to have a toothed rack drive, in which the actuator rod has a tooth system portion into which a pinion which can be driven in rotation by motor engages.

It is possible for the actuator rod to have a one-piece main body. The main body can be designed as a shaped metal part, which has the measuring portion, on which the sliding sleeve according to the invention is coaxially fixed and to which a drive portion, which has a spindle thread or a tooth system portion for example, is connected in one piece.

As an alternative, provision can be made for the main body to be composed of two or more individual axial segments.

In the various figures, identical parts are always denoted by the same reference signs, and will therefore generally also be named or mentioned only once in each case.

FIG. 1 schematically shows a steer-by-wire steering system 1 which comprises a steering column 2. This steering column has a supporting unit 21 which can be mounted on a vehicle body, not shown, and by which a steering spindle 22 can be supported rotatably about its longitudinal axis L. A steering wheel 23 is mounted rotationally conjointly on the steering spindle 22 at its driver-side end, which is at the rear with respect to the direction of travel, for inputting manual steering instructions.

A rotation angle and torque detection sensor system, not specifically shown, which converts a steering instruction introduced into the steering spindle 22 by rotation of the steering wheel 23 into an electrical control signal, is accommodated in the steering column 2.

The control signal is conducted to an electrical steering actuator 4 according to the invention via an electrical control line 3.

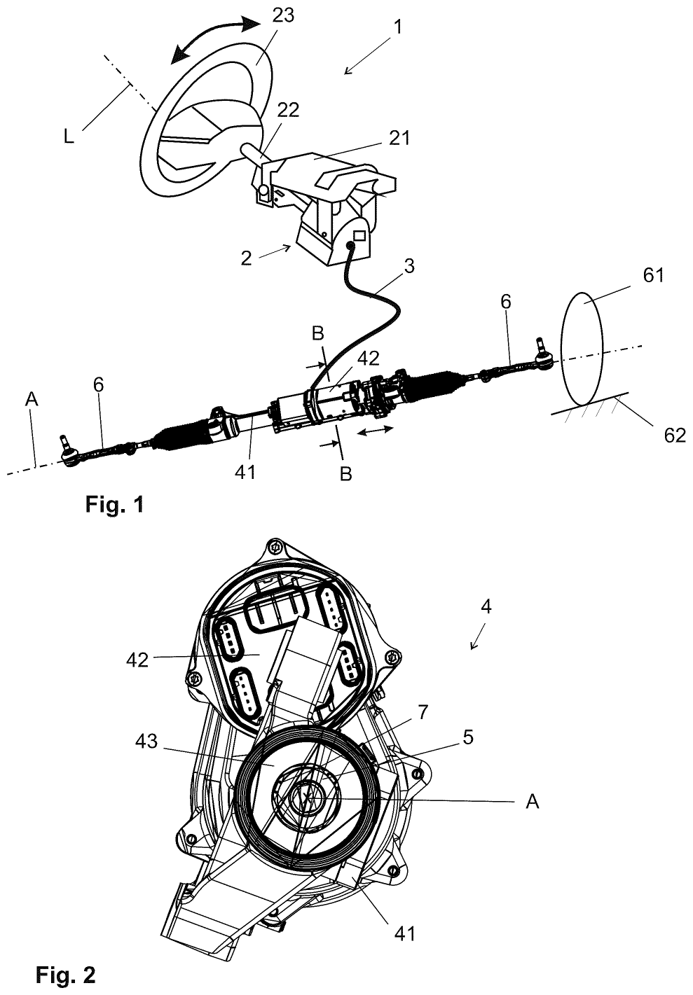

The steering actuator 4—which is shown in views of details in FIGS. 2 to 4—has an actuator rod 5 which extends along an axis A, the so-called actuator axis A, transversely to the direction of travel of the vehicle. The actuator rod is axially displaceably mounted in its longitudinal direction specified by the axis A in an actuator housing 41, as is indicated by the double-headed arrow. The actuator housing 41 has connecting elements, not shown here, for attaching it to a vehicle body, not shown.

The two outer ends of the actuator rod 5 are each connected to a steerable wheel 61 via a track rod 6, so that axial displacement of the actuator rod 5 creates a steering angle of the wheel 61 relative to the roadway 62.

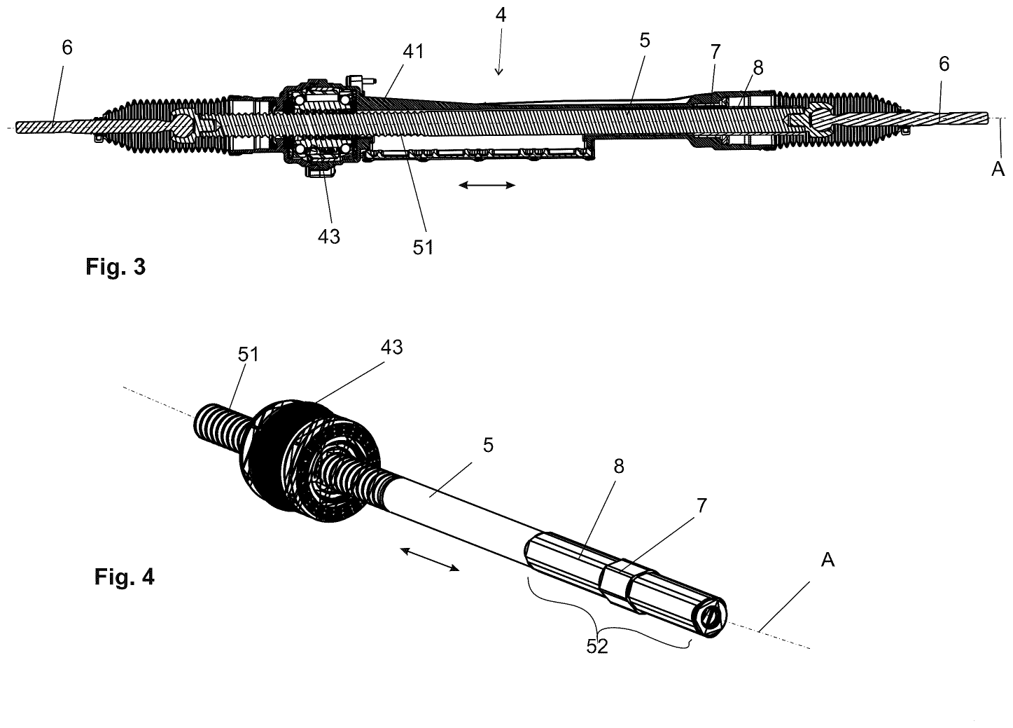

In order to produce a steering angle, the steering actuator 4 has an electromotive drive which can be electrically actuated via the control line 3 and has an electric motor 42 fitted to the actuator housing 41. An axially supported spindle nut 43, which is shown in FIGS. 2 and 3 and is rotationally mounted in the actuator housing 41, can be driven in rotation by the motor 42. A spindle thread 51 which is formed on the actuator rod 5 engages into this spindle nut. A linear spindle drive, in which the actuator rod 5 can be moved axially, i.e. back-and-forth in the longitudinal direction, as indicated by the double-headed arrow, relative to the actuator housing 41 by corresponding rotation of the motor 42, is formed in this way.

The spindle nut 43 can preferably be designed as a circulating ball nut.

FIG. 2 shows a cross section B-B perpendicular to the axis A, and FIG. 3 shows a longitudinal section along the axis A. FIG. 4 shows a perspective illustration of the spindle drive formed from the actuator rod 5 together with the spindle nut 43 schematically in isolation.

The actuator rod 5 has a cylindrical main body, which can be formed from steel bar material for example. The spindle thread 51 is made in this cylindrical main body.

The actuator rod 5 has a measuring portion 52 at an axial distance from the spindle thread 51. This measuring portion is guided through the axially continuous opening in a sliding bush 7 which is fitted in the actuator housing 41.

The measuring portion 52 and the sliding bush 7 have corresponding sensor elements, not specifically shown here, which can have sensor markings or the like which are connected to the actuator rod in a manner known per se and can be detected by means of a sensor or detecting element fitted to the sliding sleeve 8 or integrated in it, for example for detecting the position of the actuator rod 5 in the actuator housing 41.

The actuator rod 5 has a sliding sleeve 8 according to the invention in the region of the measuring portion 52. This sliding sleeve can be designed, for example, as a tube-like or tubular profile-like plastic hollow body or comprise such a hollow body. This hollow body can be designed as a plastic injection-moulded part. The sliding sleeve 8 can have, as in the examples shown, a continuous receiving opening by way of which the sliding sleeve is coaxially fixed on the actuator rod 5 axially and rotationally conjointly on the cylindrical raw material in a receiving portion of the main body.

The outer cross section of the sliding sleeve 8 is adapted to the opening cross section of the opening in the sliding bush 7 in such a way that a linear sliding guide is formed. As shown in FIG. 4, the outer cross section has a polygonal, prismatic profile, for example a square profile. This creates a linear guide with rotational security in an interlocking manner in the likewise polygonal opening, which is adapted to the profile, of the sliding sleeve 8.

The main body of the actuator rod 5 can retain the original shape of the raw material in the region of the measuring portion 52. The sliding bush 7 can be fixedly connected to the actuator rod 5 in a substance-to-substance bonded manner, for example by adhesive bonding or welding. The sliding sleeve 8 can preferably have sensor elements which can be fixedly connected to the plastic hollow body, for example by encapsulation with plastic.

The main body of the actuator rod 5 can be formed in one piece from the threaded portion 51 up to the region of the measuring portion 52.

### LIST OF REFERENCE SIGNS

1 Steering system
2 Steering column
21 Supporting unit
22 Steering spindle
23 Steering wheel
3 Control line
4 Steering actuator
41 Actuator housing
42 Motor
43 Spindle nut
5 Actuator rod
51 Spindle thread
52 Measuring portion
6 Track rod
61 Wheel
62 Roadway
7 Sliding bush
8 Sliding sleeve
L Longitudinal axis
A Actuator axis

1. A steering actuator for a steering system of a motor vehicle, comprising:
an actuator rod which is linearly movable translationally axially in its longitudinal direction relative to a sliding bush and which has a measuring portion which is displaceably mounted in an opening in the sliding bush; and
a drive device;
wherein the measuring portion and the sliding bush have a sensor apparatus which is designed to detect at least one actuator parameter;
wherein a sliding sleeve, which extends in the longitudinal direction over the measuring portion, is fitted on the actuator rod.

2. The steering actuator according to claim 1, wherein the sliding sleeve has a hollow body.

3. The steering actuator according to claim 2, wherein the hollow body has a receiving opening with a receiving cross section which has a cross-sectional shape that differs from the outer cross section.

4. The steering actuator according to claim 1, wherein the sliding sleeve is connected to the actuator rod rotationally conjointly and fixedly in the longitudinal direction.

5. The steering actuator according to claim 1, wherein the sliding sleeve is connected to the actuator rod in a substance-to-substance bonded and/or interlocking and/or force-fitting manner.

6. The steering actuator according to claim 1, wherein the sliding sleeve is held in the sliding bush in a rotationally secure manner.

7. The steering actuator according to claim 1, wherein the sliding sleeve is of torsionally rigid design.

8. The steering actuator according to claim 1, wherein the sliding sleeve is of flexurally slack design.

9. The steering actuator according to claim 1, wherein the sliding sleeve is of flexurally stiff design.

10. The steering actuator according to claim 1, wherein the sliding bush and the sliding sleeve have corresponding sensor elements.

11. The steering actuator according to claim 10, wherein the sensor elements are designed to detect a linear movement of the actuator rod relative to the sliding bush.

12. The steering actuator according to claim 10, wherein the sensor elements are designed to detect a bending and/or torsional moment applied between the actuator rod and the sliding bush.

13. The steering actuator according to claim 1, wherein the sliding sleeve comprises a plastic.

14. The steering actuator according to claim 1, wherein the actuator rod has a main body which is formed from steel.

15. The steering actuator according to claim 1, wherein the actuator rod has a one-piece main body.
